(19) United States
(12) Patent Application Publication
(10) Pub. No.: US 2014/0033174 A1
(43) Pub. Date: Jan. 30, 2014

(54) SOFTWARE BUG PREDICTING

(71) Applicants: Eitan Farchi, Pardes Hana (IL); Orna Raz-Pelleg, Haifa (IL); Amir Ronen, Haifa (IL)

(72) Inventors: Eitan Farchi, Pardes Hana (IL); Orna Raz-Pelleg, Haifa (IL); Amir Ronen, Haifa (IL)

(73) Assignee: International Business Machines Corporation, Armonk, NY (US)

(21) Appl. No.: 13/561,037

(22) Filed: Jul. 29, 2012

(51) Int. Cl. G06F 9/44

(52) U.S. Cl. 717/124

(57) ABSTRACT

A method, apparatus and product for software bug prediction. The method comprising obtaining from a plurality of developers probability estimates to areas in a plurality of code partitioned areas of a code, wherein a probability estimate is representative of an estimated probability of the area having a software bug according to a developer of the plurality of developers; and determining a testing strategy of the plurality of code partitioned areas based on the probability estimates.

### TECHNICAL FIELD

The present disclosure relates to software testing in general, and to an apparatus (system) and method for predicting bugs in software and software operated devices, in particular.

### BACKGROUND

A software bug is generally an error in software which may cause a program to stop its execution or to execute improperly. The bug may be introduced into the program due to a flaw in the software design or unintentionally by the program's developer while writing the program. If the bug is not located and corrected prior to the program being released to a user, or possibly installed in a user device, the program or device may malfunction with potentially negative repercussions to the user.

Software testing is generally conducted during a program's development stage to identify bugs. The test may check all the areas in the program which, depending on the size of the program, may be costly and time consuming. Alternatively, in order to reduce the cost and duration of the test, areas thought to have bugs, hereinafter referred to as bug-prone areas, may be selected for testing.

In some cases, testing may be performed manually, semi-automatically, automatically, or the like. The testing efforts may be focused on the entire program, on bug-prone areas, on specific aspects of the program, or the like.

### BRIEF SUMMARY

One exemplary embodiment of the disclosed subject matter is a computer-implemented method performed by a processor device, comprising obtaining from a plurality of developers probability estimates to areas in a plurality of code partitioned areas of a code, wherein a probability estimate is representative of an estimated probability of the area having a software bug according to a developer of the plurality of developers; and determining a testing strategy of the plurality of code partitioned areas based on the probability estimates.

Another exemplary embodiment of the disclosed subject matter is a computerized apparatus having a processor, the processor being adapted to perform the steps of obtaining from a plurality of developers probability estimates to areas in a plurality of code partitioned areas of a code, wherein a probability estimate is representative of an estimated probability of the area having a software bug according to a developer of the plurality of developers; and determining a testing strategy of the plurality of code partitioned areas based on the probability estimates.

Yet another exemplary embodiment of the disclosed subject matter is a computer program product comprising a non-transitory computer readable medium retaining program instructions, which instructions when read by a processor, cause the processor to performs the steps of obtaining from a plurality of developers probability estimates to areas in a plurality of code partitioned areas of a code, wherein a probability estimate is representative of an estimated probability of the area having a software bug according to a developer of the plurality of developers; and determining a testing strategy of the plurality of code partitioned areas based on the probability estimates.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of an apparatus, in accordance with some exemplary embodiments of the disclosed subject matter; and

FIGS. 3 and 4 show flowchart diagrams of methods, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

In the present disclosure a “code” may refer to a software representation of the software undergoing testing (SUT). The code may be, for example, a binary code of low level instructions, Java byte code, a high level code, or the like. The SUT may include system software, application software, or any other type of computer program, as a whole or in components of the whole program.

In the present disclosure, a “developer” may refer to a person participating in the development of the SUT. The developer may be a program designer, a code writer, software tester, quality assurance (QA) personnel, or other personnel which may be involved in the development of the software from the conceptual stage until release to client following testing. The developer may also be a user of the SUT during the development stage of the SUT. The term “developer” may also refer to one a person with past experience in development of software programs.

In the present disclosure a “testing strategy” may refer to any decision regarding how testing is performed, such as which tools/resources are being used (e.g., test generators, formal verification tools, manual testers, or the like) and how such resources are used. For example, one testing strategy may be testing only of a sub-portion of the modules of the SUT. Another testing strategy may be testing different modules using different resources, such as using formal verification tools in testing one module and using a test suite to test a second module. Yet another testing strategy may be to test different aspects of the SUT, such as to test security, test concurrency, or the like.

One technical problem dealt with by the disclosed subject matter is to identify bug-prone areas in the code. Another technical problem is to improve testing of a code by focusing testing resources in an effective manner.

As is known in the art, testing may be a resource intensive task, which may include, for example, use of model checkers, testing generators, manual labor, or the like. It may be desirable to be focus resources at areas of code which are more likely bug-prone than others. As a non-limiting example, consider a critical section which is more likely to be bug-prone in concurrent software. As another example, consider a computational intensive module, which may contain a bug, as opposed to a UI module in which it may be unlikely that a latent bug exists.

One technical solution is to crowd-source information from the collective of developers to determine which areas of code are bug-prone.

Another technical solution is to provide the developers with an incentive program which is based on the correlation between their predictions and bug detection results.

In some exemplary embodiments, developers may provide a prediction regarding their probability estimation that a bug exists in an area of code. Additionally or alternatively, a prediction of whether or not a bug exists in the code area may be accompanied by a reliability estimation of the prediction.

In some exemplary embodiments, for each area in the SUT, each developer provides an estimate of the probability that the area is a bug-prone area. For example, a developer may predict that a first area A may have a 70% probability of being a bug-prone area, a second area B may have an 85% probability of being a bug-prone area, and a third area C may have a 35% probability of being a bug-probe area. Optionally, the estimate may be a probability that the area is non-bug-prone area. Additionally or alternatively, the probability estimate may include a range, for example, for first area A, a probability ranging between 60%-80% that the area is a bug-prone area.

In some exemplary embodiments, predictions associated with the same area of code may be aggregated into a probability score (PR), which may indicate an aggregated probability of the area being bug-prone area. Based on the probability scores a testing strategy may be selected.

In some exemplary embodiments, testing strategy may be to perform testing only to those areas which the developers deem as bug-prone. Additionally or alternatively, such areas may be tested with more intensive testing tools or may be tested using more testing resources than areas which are not deemed to be bug-prone.

In some exemplary embodiments, areas displaying the highest aggregated probability of being a bug-prone area may be selected for testing. For example assuming that the SUT is partitioned into ten areas (A-I) and that the available resources allow for only checking four areas. Assume that the probability scores calculated for the ten partitions are: area A—0.1, area B—0.15, area C—0.8, area D—0.95, area E—0.22, area F—0.76, area G—0.91, area H—0.88, and area I—0.3. According to an exemplary embodiment of the present invention, the four areas with the highest probability scores are selected, that is, area D (0.95), area G (0.91), area H (0.88), and area C (0.8). In some embodiments, the probability-based prediction may be made on sub-areas within areas previously determined to be bug-prone areas. Optionally, the previously determined bug-prone areas were selected using other selection methods or prediction methods, for example, using a yes/no decision criteria.

In some exemplary embodiments, the number of areas for testing may not be a-priori determined. In some exemplary embodiments, areas may be selected in accordance with their respective probability scores until a predetermined available testing resources is determined to be insufficient for testing an additional area.

In some exemplary embodiments, prediction may include a number of bugs in each area. The prediction may additionally include an estimate of the probability that the number of bugs is correct. That is, the developer may predict that the probability that an area A has X number of bugs is P. For example, the probability of Area A having 8 bugs is 70%, that area B has 15 bugs is 85%, and of area C having 3 bugs is 35%.

In some exemplary embodiments, the prediction may be based on a scoring rule or a prediction market mechanism which includes a bonus system for rewarding the developers on the “correctness” of their prediction. Information and examples of scoring rules and prediction market mechanisms may be found in: “Prediction Markets”; Justin Wolfers & Eric Zitzewitz, Journal of Economic Perspectives, American Economic Association, vol. 18(2), pages 107-126, Spring 2004, “Strictly Proper Scoring Rules, Prediction, and Estimation”; Tilmann Gneiting, Adrian E Raftery. Journal of the American Statistical Association, Mar. 1, 2007, 102(477): 359-378, both of which are hereby incorporated by reference.

In some exemplary embodiments, the bonus may be computed so as to provide an incentive for a developer to provide an estimated probability of a bug existing in an area that is equal to the actual probability of such a bug existing in the area. As an example only, the expected bonus may be computed so as to be maximized when declaring the actual probability.

One technical effect of utilizing the disclosed subject matter is utilizing the developers' knowledge and intuition to focus testing resources on bug-prone areas of the SUT.

Another technical effect is increasing the developers' motivation to provide a correct answer based on an incentive program.

Another technical effect is increasing the reliability of the prediction process as a result of the increased motivation of the developers.

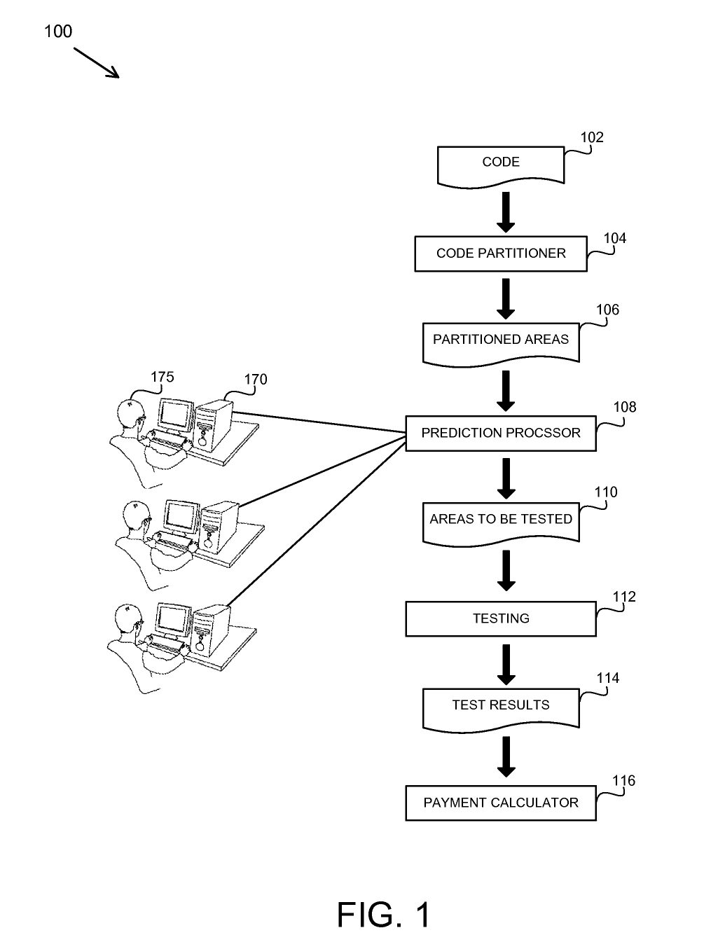

Referring now to FIG. 1 showing a computerized environment 100 in which the disclosed subject matter is used, in accordance with some exemplary embodiments of the subject matter.

In some exemplary embodiments, a developer 170 may interact with a computerized environment 100. The developer 170 may utilize a Man-Machine Interface (MMI) 175 such as a terminal, a display, a keyboard, an input device or the like. In some exemplary embodiments, a plurality of developers may interact with the computerized environment 100.

In some exemplary embodiments, a code 102 which is a software representation of the SUT, may be partitioned into partitioned areas 106 by a code partitioner 104. The partitioning may be automatically performed and may include use of any known code partitioning algorithm. Additionally or alternatively, code 102 or portions thereof may be manually partitioned by the developers. Manual partitioning may be based on the developers' judgment. The partitioning may include parsing the code 102 and determining a tree representation thereof or other type of hierarchical structure. Partition areas 106 may be relatively large sized and may include one or more software modules, where each module may be associated, for example, with one or more branches in the parse tree. Additionally or alternatively, partitioned areas 106 may be relatively small and may include one or more software sub-modules, where each sub-module may be associated with a portion of a branch, or a single node (task) on the tree. Additionally or alternatively, code 102 may be partitioned into areas of different relative sizes. In some embodiments, area of partitioned areas 106 may have been previously determined to be a bug-prone area which is being partitioned into smaller areas for selecting bug-prone sub-areas.

In some exemplary embodiment, a prediction processor 108 may be configured to obtain predictions from the developers. The prediction processor 108 may select a subset of areas (areas to be tested 110) from partitioned areas 106. Areas to be tested 110 may be selected based on their probability scores, which may be the highest compared to the other areas in partitioned areas 106. A number of test areas selected may be further determined based on the available testing resources. Probability scores may be calculated by prediction processor 108 by aggregating the probability data included in the predictions made by the developers for each area in partitioned areas 106. The predictions may be motivated by a scoring rule or a prediction market mechanism.

In some exemplary embodiments, a developer may provide probability estimation that an area of the partitioned areas 106 is bug-prone. Probability estimates may be a value in the range from 0 to 1 (100%) wherein an area which the developer is convinced has no bugs may be assigned a probability value of 0, and an area which the developer is convinced there is a bug may be assigned a value 1 (100%). Values in between reflect a developer's confidence (or lack of confidence) as to the certainty of an area having a bug. Alternatively, the probability estimate may be a range of values. For example, the developer may estimate that there is 20% probability that a bug exists in area A and 60% probability that a bug exists in area B. Additionally or alternatively, a developer may provide a range of values, such as between 50% and 60%. In some exemplary embodiments, substantially each developer may provide an estimate with respect to substantially each area.

Additionally or alternatively, the developer may classify the area as “yes” being a bug-prone area, or “no” being a non-bug-prone area and provide an estimated probability that the classification is correct. Probability estimates may be a value in a range from 0 to 1 (100%) wherein a 0 represents the developer has absolutely no confidence in the prediction and a 1 represents complete confidence in the prediction, with varying degrees of confidence represented by the values in between. Additionally or alternatively, the probability estimate may be a range of values, for example, between 0.5-0.6 (e.g. 50%-60%).

In some exemplary embodiments, the predictions may additionally or alternatively include a number of bugs estimated to be in the bug-prone areas, and optionally a probability estimate reflecting a developer's confidence that the predicted number of bugs may be correct.

In some exemplary embodiments, in accordance with a testing strategy determined by prediction processor 108, such as testing only areas to be tested 110, testing 112 may be performed. In some exemplary embodiments, testing may be performed by an automatic testing device, by a developer, or the like. During testing 112, areas 110 may be checked for bugs, such as by invoking functionality associated with areas 110.

Test results 114 may be determined which may include a number of bugs detected in each of test areas 110. Additional information in test results 114 may include identification of areas where no bugs where detected.

In some exemplary embodiments, a payment calculator 116 may evaluate the information in test results 114. This information may be compared with stored parameters associated with a prediction market mechanism, or a scoring rule, for evaluating the reliability of the predictions made by the developers. For convenience hereinafter, use of the term “prediction market mechanism” include the option of a scoring rule being implemented. Reliable predictions made by a developer may entitle the developer to a bonus under a bonus system implemented as part of the prediction market mechanism. The type of reward and/or the value of the bonus, may be influenced by many factors. Bonus criteria (e.g. amount of bonus and type of bonus, the influencing factors, etc.) may or may not be known to the developers prior to making their predictions. It will be understood that if such information is known a-priori it may be useful for increasing their motivation to provide a more reliable prediction. For example, a larger or more valuable bonus may be given for a positive prediction of a bug detected in a smaller area compared to a larger area; or for positively predicting a bug in a function; or for positively predicting bugs in a single test area among many test areas which do not have bugs; or for positively predicting a larger number of bugs in a test area compared to other test areas; or for predicting areas without bugs; or for unique contribution with respect to other developers, such as by correctly predicting an area to be bug-prone when other developers predicted that the area is more likely to be non-bug-prone; among other criteria. The bonus may include any suitable instrument for creating an incentive in the developers to provide more reliable predictions, such as for example, real money, funny money, reputation, gift coupons, salary points, vacation points, and the like.

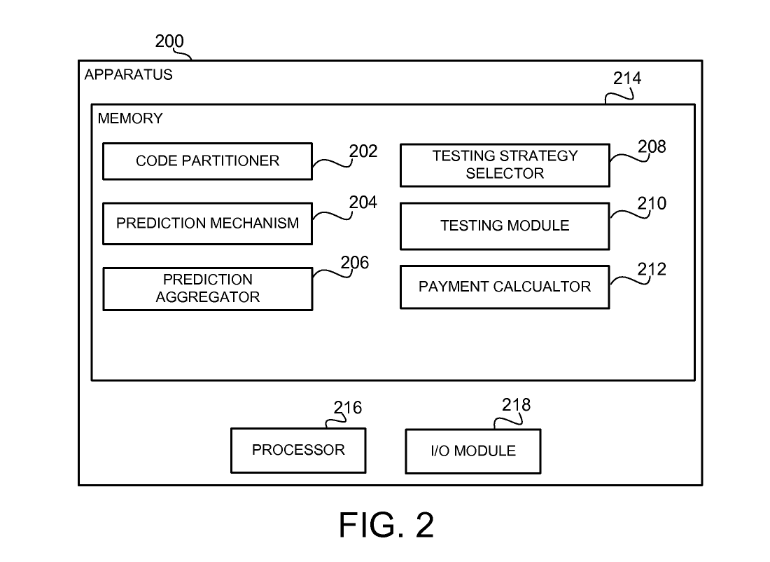

Referring now to FIG. 2 showing an apparatus in accordance with some exemplary embodiments of the disclosed subject matter. Apparatus 200 may be configured to provide software bug prediction, in accordance with the disclosed subject matter.

In some exemplary embodiments, Apparatus 200 may comprise a processor 216. The processor 216 may be a Central Processing Unit (CPU), a microprocessor, an electronic circuit, an Integrated Circuit (IC) or the like. Processor 216 may be utilized to perform computations required by the apparatus 200 or any of it subcomponents. Processor 216 may be configured to execute computer-programs useful for reliably predicting location of software bugs in a SUT.

In some exemplary embodiments of the disclosed subject matter, Apparatus 200 may comprise an Input/Output (I/O) module 218. I/O module 218 may be utilized to provide an output to and receive input from a developer, such as 175 of FIG. 1. However, it will be understood that the apparatus 200 may be utilized without user intervention. In some exemplary embodiments, I/O module 218 may be utilized to obtain, such as from a digital source, from developer 175, or the like, code 102, partitioned areas 106, areas to be tested 110, probability estimates by the developers, testing strategy, or the like. I/O module 218 may further be used to output, optionally in computer-readable medium, partitioned areas 106, areas to be tested 110, test results 114, or the like.

In some exemplary embodiments, Apparatus 200 may comprise a Memory Unit 214. Memory Unit 214 may be a short-term storage device or long-term storage device. Memory Unit 214 may be a persistent storage or volatile storage. Memory Unit 214 may be a disk drive, a Flash disk, a Random Access Memory (RAM), a memory chip, or the like. In some exemplary embodiments, Memory Unit 214 may retain program code operative to cause Processor 216 to perform acts associated with any of the subcomponents of Apparatus 200. In some exemplary embodiments, Memory Unit 214 may retain program code operative to cause Processor 216 to perform acts associated with reliably predicting location of software bugs in a SUT. Memory Unit 214 may be used to retain results of comparison with stored parameters associated with a prediction market mechanism, bonus criteria, test results, and the like.

The components detailed below may be implemented as one or more sets of interrelated computer instructions, executed for example by Processor 216 or by another processor. The components may be arranged as one or more executable files, dynamic libraries, static libraries, methods, functions, services, or the like, programmed in any programming language and under any computing environment.

Code Partitioner 202 may be configured to a partition a code representative of a SUT into areas. The partitioning may be into one or more software modules and/or sub-modules and may include use of any known code partitioning algorithm. Additionally or alternatively, Code Partitioner 202 may be configured to partition the code based on a commands, rules or selections made by a user, such as developer 175. Additionally or alternatively, Code Partitioner 202 may partition the code based on a manual partitioning of the code by the user. Code Partitioner 202 may have the same or similar functionally to code partitioner 104 in FIG. 1.

Prediction Obtainer 204 may be configured to receive and process the predictions made by the developers for the partitioned areas. Processing may include classifying and storing the predictions, according to bug-prone areas and non-bug-prone areas. Prediction Mechanism 204 may be further configured to receive and process the probability estimates included in the predictions. Prediction Obtainer 204 may have the same or similar functionally to Prediction Processor 108 of FIG. 1.

Prediction Aggregator 206 may be configured for calculating a probability score for substantially each area based on developers' predictions. Prediction Aggregator 206 may have the same or similar functionally to code Prediction Processor 108 of FIG. 1.

Testing Strategy Selector 208 may be configured to select a testing strategy for the code based on the probability scores. In some exemplary embodiments, Testing Strategy Selector 208 may be configured to compare the probability scores calculated for each area and for selecting test areas to undergo testing. Test areas selected by Testing Strategy Selector 208 may have the highest scores. Testing Strategy Selector 208 may be further configured to process information associated with available test resources and to select a number of test areas based on this processed information. Testing Strategy Selector 208 may have the same or similar functionally to Prediction Processor 108 of FIG. 1.

Testing Module 210 may be configured to evaluate the results of testing conducted on the selected test areas, and to output the results. The data output may include such information as identification of test areas with detected bugs, number of bugs detected, identification of areas which are bug-free, and the like. Testing Module 210 may be configured to perform testing 112 in FIG. 1.

Payment Calculator 212 may be configured to compare the test results output by Testing Module 210 with the prediction data input to Prediction Mechanism 204, and may determine the reliability of a prediction. Payment Calculator 212 may further be configured to compute a bonus to be paid to a developer for a reliable prediction, the computation of which may be based on optionally predetermined bonus criteria. Payment Calculator 212 may be additionally configured to compute a penalty fee for penalizing a developer for an unreliable prediction. Payment Calculator 212 may be the same or functionally similar to Payment Calculator 116 in FIG. 1.

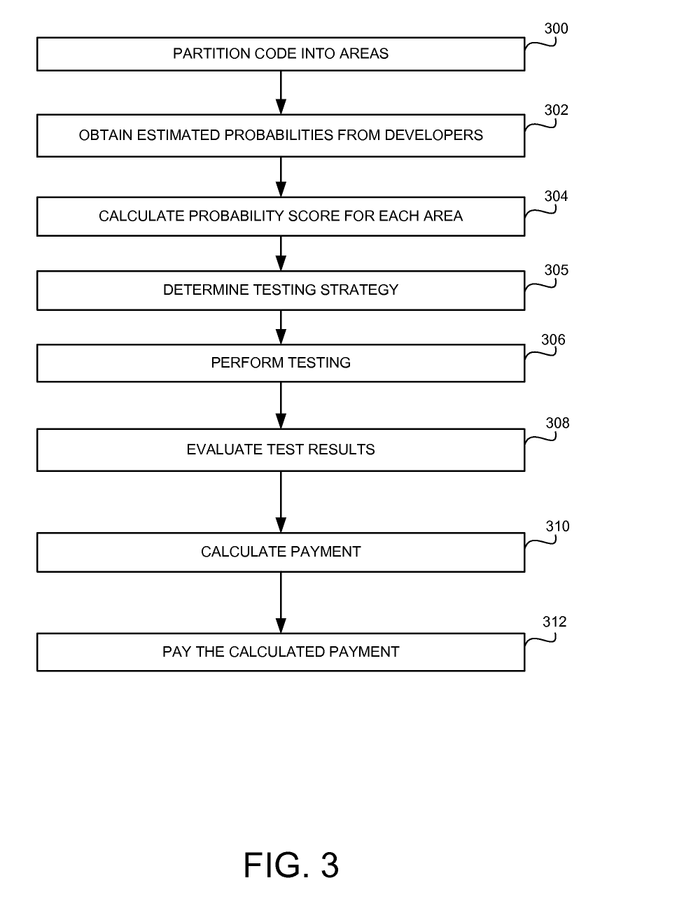

Referring now to FIG. 3 showing a flowchart diagram of a method of predicting bug-prone areas in a SUT using a prediction market mechanism, in accordance with some exemplary embodiments of the disclosed subject matter.

In Step 300 a code is partitioned into areas. Partitioning can be performed either manually or automatically.

In Step 302, predictions, such as for example estimated probabilities, which may be made by the developers, may be obtained. The predictions may be obtained either directly or indirectly from the developers. In some exemplary embodiments, each developer may assign an estimated probability that there exists a bug in an area of the code.

In Step 304 the probability scores of substantially each area are computed.

In Step 305, a testing strategy may be determined based on the computed probability scores. In some exemplary embodiments, those areas with the highest probability scores may be selected as test areas. A number of test areas may be determined based on the test resources available.

In Step 306, testing is performed on the selected test areas. Testing may be performed automatically, manually, in combination thereof, or the like.

In Step 308, the results of the testing are evaluated for determining areas with bugs, and other related information.

In Step 310, a bonus for a reliable prediction is calculated. Optionally, a penalty fee is calculated for an unreliable prediction.

In Step 312, payment of the bonus may be performed. In some exemplary embodiments, information may be provided to a billing server, a server in charge of computing salaries, or the like for automatically paying the bonus. Additionally or alternatively, the bonus may be paid or otherwise bestowed manually or automatically.

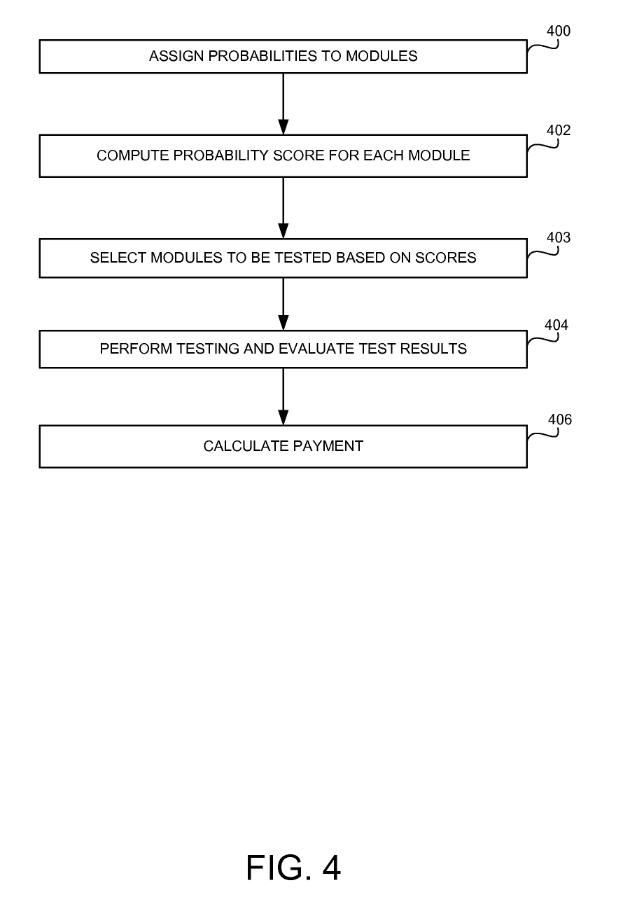

Referring now to FIG. 4 showing a flowchart diagram of a method of selecting a module for software testing using a prediction market mechanism, in accordance with some exemplary embodiments of the disclosed subject matter. The method is described using an exemplary scenario of a code made up of 5 modules of which only one module may be selected for testing.

In Step 400, each developer may predict for each one of the five modules a probability estimate indicative of the probability that the modules have bugs.

In some exemplary embodiments, the predictions may be kept secret for preventing the developers from possibly influencing one another.

In some exemplary embodiments, developers that worked on a particular module may be prevented from providing a prediction regarding the module they worked on as a measure to reduce a possible incentive to introduce a bug into the module. The predictions may be denoted Sᵢ(j), where i corresponds with the developer making the prediction and j corresponds with the module on which the prediction is being made.

In Step 402, the probability scores (PS) are determined for all the modules and the module with the highest PS is selected for testing. PS of module j may be calculated based on an average estimation, PS=1/n*□Sᵢ(j). For example, if module 1 is given the estimated probabilities of 0.4, 0.5, 0.7 and 0.8, the PS may be computed to be 0.6.

In Step 403, based on the computed PS, modules to be tested may be selected. For example, if PS=0.6 (module 1), 0.3 (module 2), 0.3 (module 3), 0.3 (module 4), and 0.2 (module 5), then module 1 may be selected for testing. In some exemplary embodiments, additional modules may also be selected for testing.

In Step 404, testing is performed on the module, for example module 1, and the results may be evaluated to determine whether or not a bug was detected in module 1.

In Step 406, payment is calculated based on whether or not bugs were detected in the tested module. Payment may be calculated, for example, according to the following bonus model:

If a bug is detected, 2·Sᵢ(j)−(Sᵢ(j)²+(1−Sᵢ(j))²); and
if a bug is not detected, 2·(1−Sᵢ(j))−(Sᵢ(j)²+(1−Sᵢ(j))²).

Additionally or alternatively, the bonus model may be:
If a bug is detected, 1−(1−Sᵢ(j))²; and
if a bug is not detected, 1−(Sᵢ(j))²

In some exemplary embodiments, the bonus model may be configured to yield maximal expected value when the value Sᵢ(j) is the actual probability of detecting a bug in the module j.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”]and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method performed by a processor device, comprising:
obtaining from a plurality of developers probability estimates to areas in a plurality of code partitioned areas of a code, wherein a probability estimate is representative of an estimated probability of the area having a software bug according to a developer of the plurality of developers; and
determining a testing strategy of the plurality of code partitioned areas based on the probability estimates.

2. The computer-implemented method of claim 1 further comprising:
in response to testing the code based on the testing strategy, determining in which areas of the plurality of code partitioned areas, a bug was detected; and
calculating for each developer a bonus based on a correlation between the developer's probability estimates and bug detection during said testing.

3. The computer-implemented method of claim 2 further comprising calculating the bonus according to a scoring rule or a prediction market mechanism.

4. The computer-implemented method of claim 2, wherein said calculating comprises:
computing for a developer an area bonus associated with substantially each area; and
aggregating the area bonuses of the developer into the bonus.

5. The computer-implemented method of claim 4, wherein said computing the bonus associated with an area denoted as j by a developer denoted by i comprises:
in case a bug was detected in the area, compute 1−(1−Sᵢ(j))²;
in case a bug was not detected in the area, compute 1−Sᵢ(j)²; and
wherein Sᵢ(j) is the probability estimate by the developer i that a bug exists in area j.

6. The computer-implemented method of claim 2 further comprising testing the code based on the testing strategy.

7. The computer-implemented method of claim 1, wherein said determining comprises:
for each area in the plurality of code partitioned areas, aggregating the one or more probability estimates associated with different developers and computing a probability score; and
selecting the testing strategy based on the probability scores.

8. The computer-implemented method of claim 1 further comprising partitioning the code into said plurality of partitioned code areas.

9. The computer-implemented method of claim 1, wherein a developer is excluded from providing a probability estimate with respect to an area which the developer developed.

10. The computer-implemented method of claim 1, wherein the testing strategy is selected from the following strategies:
testing a subset of the areas; and
testing each area using a different testing technique.

11. A computerized apparatus having a processor, the processor being adapted to perform the steps of:
obtaining from a plurality of developers probability estimates to areas in a plurality of code partitioned areas of a code, wherein a probability estimate is representative of an estimated probability of the area having a software bug according to a developer of the plurality of developers; and
determining a testing strategy of the plurality of code partitioned areas based on the probability estimates.

12. The computerized apparatus of claim 11, the processor being further adapted to perform the steps of:
determining, in response to testing the code based on the testing strategy, in which areas of the plurality of code partitioned areas, a bug was detected; and
calculating for each developer a bonus based on a correlation between the developer's probability estimates and bug detection during said testing.

13. The computerized apparatus of claim 12, the processor being further adapted to calculate the bonus according to a scoring rule or a prediction market mechanism.

14. The computerized apparatus of claim 12, wherein said calculating comprises:
computing for a developer an area bonus associated with substantially each area; and
aggregating the area bonuses of the developer into the bonus.

15. The computerized apparatus of claim 14 wherein said computing the area bonus associated with an area denoted as j by a developer denoted by i comprises:
in case a bug was detected in the area, compute 1−(1−Sᵢ(j))²;
in case a bug was not detected in the area, compute 1−Sᵢ(j)²; and
wherein Sᵢ(j) is the probability estimate by the developer i that a bug exists in area j.

16. The computerized apparatus of claim 11, the processor being further adapted to test the code based on the testing strategy.

17. The computerized apparatus of claim 11, wherein said determining comprises:
for each area in the plurality of code partitioned areas, aggregating the one or more probability estimates associated with different developers and computing a probability score; and
selecting the testing strategy based on the probability scores.

18. The computerized apparatus of claim 11, the processor being further adapted to partition the code into said plurality of partitioned code areas.

19. A computer program product comprising :
a non-transitory computer readable medium retaining program instructions, which instructions when read by a processor, cause the processor to perform the steps of:
obtaining from a plurality of developers probability estimates to areas in a plurality of code partitioned areas of a code, wherein a probability estimate is representative of an estimated probability of the area having a software bug according to a developer of the plurality of developers; and
determining a testing strategy of the plurality of code partitioned areas based on the probability estimates.

20. The computer program product of claim 19 wherein the program instructions when read by the processor further cause the processor to perform the steps of:
determining, in response to testing the code based on the testing strategy, in which areas of the plurality of code partitioned areas, a bug was detected; and
calculating for each developer a bonus based on a correlation between the developer's probability estimates and bug detection during said testing.
